(19) United States
(12) Patent Application Publication
(10) Pub. No.: US 2024/0088831 A1
(43) Pub. Date: Mar. 14, 2024

(54) HYBRID SOLAR PANEL WITH A TRANSPARENT LIQUID THERMAL COLLECTOR, THE METHOD OF MANUFACTURING OF THE HYPRID SOLAR PANEL

(71) Applicants: Olena Bagirova, Odesa (UA); Oleksii Kurhusov, Odesa (UA)

(72) Inventors: Olena Bagirova, Odesa (UA); Oleksii Kurhusov, Odesa (UA)

(21) Appl. No.: 18/260,480

(22) PCT Filed: Nov. 1, 2021
(86) PCT No.: PCT/IB2021/060102

§ 371 Date: Jul. 6, 2023

(51) Int. Cl. H02S 40/44; F24S 10/50; H02S 40/42

(52) U.S. Cl. CPC H02S 40/44; F24S 10/501; H02S 40/425; F24S 2020/17

(57) ABSTRACT

A hybrid solar panel, comprising a photovoltaic panel coupled with transparent liquid thermal collector filled with coolant. Role of heat adsorber is coolant selectively transparent in the range of 400-1100 nm. Such panel is coupled with thermal collector by lamination.

### TECHNICAL FIELD

The present invention relates to a hybrid solar panel, comprising photovoltaic cells and transparent liquid thermal collector for cooling said photovoltaic cells arranged for a transfer of heat flow to a fluid coolant, e.g. water, conveyed to the outside for other uses or heat storage.

In particular, the invention relates to a hybrid solar panel comprising:
a monofacial or bifacial photovoltaic layer including a plurality of photovoltaic cells,
a transparent liquid thermal collector comprising coolant for said photovoltaic cells,
a manifold arranged to convey a fluid, particularly a liquid, in a thermal exchange relationship with the said transparent liquid thermal collector.

Further, the present invention relates to a transparent liquid thermal collector comprising means for heat exchange between the photovoltaic panel, a heat adsorber, and inlet and outlet means.

Further, the present invention relates to a thermal absorber means allowing effective and reliable functioning of said invention keeping its weight and cost on a commercially attractive level.

Further, the present invention relates to a method of manufacturing such a solar panel by coupling a photovoltaic panel with a transparent liquid thermal collector to achieve a high degree of heat exchange between the photovoltaic panel and a transparent liquid thermal collector and to avoid overheating of the photovoltaic panel.

Further, the present invention relates to a method of raising the effectiveness of photovoltaic panel assembly allowing to save space where it is necessary and critical.

### BACKGROUND ART

The known hybrid solar collector according to the patent of Ukraine [UA110846, publ. 25 Feb. 2016], which consists of a photovoltaic panel and has a metal plate of the adsorber and a cooling tubular collector, located on the rear side of the structures. The design of this module, built on the principle of “sheet-and-tube” allows you to partially prevent the temperature drop of the photovoltaic efficiency by cooling its rear surface, but also imperfect.

Known design of the combined photothermal module, the body of which is made entirely of cellular polycarbonate according to the patent of Ukraine [UA51073, publ. 25 Jun. 2010]. In this design, the scheme of photocells is installed between the protective translucent coating located in front of its front surface and the heat panel of the collector made of cellular polycarbonate, which allows to slightly reduce heat loss in the cold season.

The disadvantage of this design is the inconsistency of the refractive indices of light during the passage of radiation to the surface of photocells through the air-filled hollow structure of the material, leading to scattering of sunlight and, as a result, reduced electric power generation by 6-8%. The hybrid module made entirely of cellular polycarbonate is not reliable, because filled with coolant cannot withstand its own weight, so its design on the backside has to be strengthened with a metal plate. In addition, the front surface of the polycarbonate module is not resistant to abrasive damage, resulting in a gradual decrease in its performance.

In the prior art document, U.S. Pat. No. 4,392,008A disclosed combined electrical and thermal solar collector with an improved combination of the electrical and thermal solar panel assembly where the lower portion of the housing cavity is filled with a suitable heat-insulating material, to a depth such as to cover the flow tubes and the major portions of the header tubes, acting also to provide cushioned support for the sheet-and-tube assembly comprising the plate members and parts associated therewith.

It is obvious that the heat exchange rate is insufficient due to the small surface of contact between cells and the heat thermal part. An additional disadvantage is the high temperature of the coolant and therefore higher temperature or panels which reduces the service life.

In the prior art document, U.S. Pat. No. 4,545,365A disclosed a fluid heating system utilizing solar energy and waste heat where the thermal collector is positioned to receive solar radiation to heat the refrigerant flowing there through. The thermal collector is designed such that the refrigerant is at least partially vaporized before flowing out of the thermal collector through the outlet. The use of freons significantly complicates construction and utilization.

In the prior art document, US2002189662A1 disclosed a device for producing solar energy and water where photovoltaic element and thermal collector coupled through the metal adsorber. A disadvantage of such an approach is an increase of total weight of device and complexity of its manufacturing and further transparent sheet before panel reduces transparentness and thus reduces the production of electricity whereas excessive thermal insulation causes the panel to overheat.

In the prior art document, US2007186922A1 disclosed a solar panel with a translucent multi-walled sheet for heating a circulating fluid where channels of heat exchanger made with a number of zigzags. On the one hand, this allows to harvest on the output of heat exchanger coolant with higher temperature but significantly raises resistance for flow of the coolant and increases the temperature gradient of the cooled photovoltaic circuit, too.

In the prior art document, US2013036752A1 disclosed system and method for cooling photovoltaic cells where utilized several directional schemes for flowing coolant in the heat exchanger but it still uses the evaporation of coolant leading to the complexity of construction of cooling part of the device that restricting its widespread in practice.

In the prior art document, JP2014020759A disclosed solar thermoelectric cogeneration panel and method for attaching the same, and solar thermoelectric cogeneration system also utilizes S-type tube for coolant. Such an approach does not provide sufficient uniformity of cooling of photocells. Uniformity is important because of the weakness of the PV circuit defined by the weakest cell in this case poorly cooled and thus overheated.

In the prior art document, US2016322932A1 disclosed hybrid solar thermal system utilizes both metal pipes and S-type configuration of them, therefore, combining described above disadvantages of both. Some of the embodiments include a sheet-and-tube heat collector configuration and the use of big energy-consuming refrigeration equipment.

Closest to present invention prior art is disclosed in Korean patent application KR20130071830A disclosed photovoltaic module cooling apparatus and the manufacturing method where to solve the problem of power generation efficiency deterioration of the solar module due to temperature rise. APPARATUS is presented by a ready-made polycarbonate panel having the partition wall is cut according to the size of the solar module to construct the heat-dissipating panel portion of the cooling device. The upper and lower partition walls of the polycarbonate panel are partially cut to form a flow path of the coolant. The upper cover and the lower cover are coupled to the top and bottom of the polycarbonate panel, respectively, and sealed. The upper cover and the lower cover constitute inlet and outlet portions and the inlet and outlet pipes and of the coolant are connected. Of course, the upper cover and the lower cover constituted by the inlet and outlet portions may be coupled to the upper and lower portions of the panel and then sealed. The upper cover and the lower cover are made of materials that are easy to process to fit the sizes of the upper and lower portions of the polycarbonate panel and are easily structured of the inlet and outlet portions desirable. Then, the above-described cooling apparatus is attached to the rear surface of the solar module.

The solar module cooling apparatus includes a heat dissipation panel portion attached to a rear surface of a solar module in a shape in which upper and lower partitions are partially cut, A upper cover sealed and bonded to upper and lower portions of a carbonate panel, a cover portion provided with an lower cover, a upper cover and an lower cover for entering/and an inlet/outlet of the antifreeze.

The disadvantage of the proposed solution is top to bottom flow of the cooling liquid and the method of supplying the coolant that does not ensure uniformity of cooling of the whole width of the panel. In addition, the circulation system of these hybrid modules uses brines, as well as refrigeration equipment.

RU2731162C1 A hybrid photovoltaic module containing a protective glass coating, switched solar cells located between the glass and the casing with a heat exchanger, characterized in that the solar cells are electrically insulated from the heat exchanger, the space between the solar cells and the heat exchanger, as well as between the glass cover and the solar cells is filled with a layer of siloxane gel 0.5-2 mm thick, the heat exchanger is made in the form of a sealed chamber with an anodized aluminum absorber and channels for coolant circulation made of cellular polycarbonate, and the total area of the connected solar cells is comparable to the area of the upper base of the heat exchanger body.

The main disadvantage of this design of the hybrid module is the presence of a metal heat absorber, which worsens the heat transfer characteristics between the panel and the coolant. In addition, coupling the adsorber to the photovoltaic circuit by pouring siloxane gel technologically complicates the manufacture of the device.

Problems of the prior art can be summarized as follows:

Incomplete removal of thermal power due to uneven contact of coolant with the surface of photovoltaic cells of modular design, in particular, due to the significant distances between the cooling tubes or channels.

The presence of a metal heat adsorber, acting as an additional mediator in heat transfer and increases weight, size, and cost to the module.

Excessive thermal insulation of the module in order to obtain the advantage of thermal performance over electrical.

Deterioration of the optical efficiency of electrical conversion when installing additional glass in front of the front surface of the module and excessive insulation.

Use of long S-shaped channels or tubes with a large number of turns for circulation of the coolant in a modular design increases system power consumption.

The complexity of the modular design involves a large component of manual labor.

### SUMMARY OF INVENTION

The object of the invention is achieved by a hybrid solar panel having the features forming the subject of one or more of the following claims, which form an integral part of the technical disclosure herein provided in relation to the invention.

Briefly, the present invention provides means for removal of heat from PVPs and transport heat to the consumer and thus we prevent falling of efficiency and we extend the service life of panels.

In particular, the object of the present invention provides hybrid solar panel [FIG. 2], where a photovoltaic panel coupled with a transparent liquid thermal collector presented by multi-channel polymer panel, connected with heat storage or heat consumer by supply inlet and drain outlet pipes, whereas the role of heat adsorber is put on the coolant. The proposed model provides efficient and uniform heat dissipation from photovoltaic panels resulting in higher efficiency.

### Technical Problem

A widely known problem is that heat generated by the photovoltaic panels during the heating is higher than electricity but not effectively used. For collecting of heat energy from the place of its collecting and transferring it to consumption the part of generated electricity shall be spent.

As it can be seen from prior art designers of photovoltaic panels have tried many approaches to overcome this disadvantage. Unfortunately, along with success with cooling of panels these approaches had several disadvantages such as insufficient volume and uniformity of cooling, higher power consumption, and high energy loss on the functioning of the cooling system.

### Solution to Problem

After many models being tested by inventors came to some conclusions: 1) best carrier for coolant is a transparent multi-channel polymer panel which has acceptable heat transfer rates and is advantageous due to the lower weight compared to metal or glass and provides the ability to create module construction on the base of bifacial photovoltaic panels, 2) coolant must play the role of the heat adsorber, 3) linear and laminar flow of coolant is advantageous because of low flow resistance and accordingly power consumption.

All these conclusions were utilized in the design of the present hybrid solar panel where a photovoltaic panel coupled with a transparent liquid thermal collector presented by multi-channel polymer panel, connected with heat storage of heat consumer by supply inlet and drain outlet pipes, whereas the role of heat adsorber is put on the coolant and industrial applicability and benefit achieved by coupling of the photovoltaic panel with thermal collector by means of laminating that is in complex and in details is the present invention.

### Advantageous Effects of Invention

A skilled person in this field can appreciate vary of combinations of methods of the inventions with options and modifications. However, inventors propose the best solution for realizing the current invention in the following details.

Main advantage of the present invention is higher electrical output compared to uncooled panels achieved by cooling of the panel bearing. Important that heat collected by the hybrid solar panel of the invention directed to consumption whereas, amount of heat energy is 2 to 4 times more than electricity and some technical solutions of the prior art are partially or completely dissipating heat from cooling to the environment. Optimization of electric and thermal power generation conditions allowed to achieve the total efficiency of the hybrid solar panel up to 95%, a minor part of the electricity generated by PV-panel consumed to the functioning of the cooling system.

Most of the commercially available photovoltaic panels can be taken for coupling by means of lamination with a transparent multi-channel polymer panel. As soon as a variety of commercially available polymer panels are offered by the market, inventors recommend using those having thickness of walls 0.5 to 2 mm with overall thickness 5 to 20 mm with near round or near square cross-section of channels of the panel. Polymer material of panel must have at least average UV-stability and resistance to provide acceptable service life of the thermal collector. Further material of panel must be inert to components of coolant and maintain sufficient transparency during all service life.

As it can be seen in the summary of the invention that provided hybrid solar panel comprises no special heat adsorber plate of layer instead the role of heat adsorber put on coolant. Moreover, coolant can be selectively transparent absorbing solar radiation out of range of the maximum efficiency of a photovoltaic panel. Such selective of transparency allows to harvest reflected heat and thus to preserve from additional undesired heating the additional photovoltaic surface on the rear side of photovoltaic panel but provide transparency for desired spectrum (400-1100 nm) [1] and thus to be collected reflected radiation in its turn giving additional power effectiveness where critical is space but demanded high power efficacy [see FIG. 5]. Additionally, a transparent heat absorber makes it possible to provide hybrid solar panels with bifacial PVPs.

Hybrid solar panels with two light-converting surfaces are recommended by the inventors to be used in combination with diffuse/mirror reflectors of solar radiation due to their high total efficiency and lack of overheating under conditions of concentrated light fluxes. The temperature of the coolant at the outlet of the module should not exceed 50-550, which is achieved by regulating its flow in the circulation system.

Further, feature of invention is method of supply of coolant and device allowing effectiveness of such. Inventors had come to conclusion that coolant must flow in the thermal collector linearly and laminar because of low flow resistance and coolant flow must be in vertical direction from the bottom up. To provide flow uniformity of the coolant on the inlet and outlet of the collector, to avoid any cavitation and minimize energy consumption of the circulation system preferably they must have design as shown on [FIG. 6].

Where a photovoltaic panel coupled with a transparent liquid thermal collector presented by multi-channel polymer panel, connected with heat diversion or transfer to heat consumer by supply inlet and drain outlet pipes, whereas heat adsorber is represented by the coolant and industrial applicability and benefit achieved by coupling of the photovoltaic panel with the thermal collector by laminating that is in complex and in details is the present invention.

Further, hybrid solar panel of the invention does not require a constant water supply from external sources of water for cooling, only coolant closed in cooling system. On the other hand, and more advantageously, heat and less electricity produced the hybrid solar panel of the invention can be further utilized for desalination of sea water in coastal regions rich in heat and sun but poor in fresh water, however, hear collected from PVPs can be utilized on vary application, e.g. heated floor or all-season swimming pools.

### BRIEF DESCRIPTION OF DRAWINGS

FIG. 1 Temperature of coolant (1—prior art, 2—invention). Shown the difference between the temperature of coolant fluid in the prior art model and invention. Proposed model allows to keep photovoltaic panel below the critical temperatures and keep their productivity at desired level.

FIG. 2 Cross-section of a hybrid solar panel according to present invention/

FIG. 3 Common functional scheme of a hybrid panel according to the present invention. Shown 1—pump, 2—heat storage/consumer, 3—hybrid solar panel.

FIG. 4 Shown cooled (right) and uncooled (left) panels. It can appreciate that photovoltaic panel cooled with a thermal collector of the present invention has lower temperature compared to the uncooled.

FIG. 5 Diagram showing loss of power efficacy by a photovoltaic panel with raising of its temperature at noon whereas cooled panel raising power output.

FIG. 6 Inlet and outlet collectors for coolant.

FIG. 7 Characteristics and effectiveness of uncooled PV panel, total efficiency of separately located PV-panel and thermal panel compared to Hybrid PV-T panel.

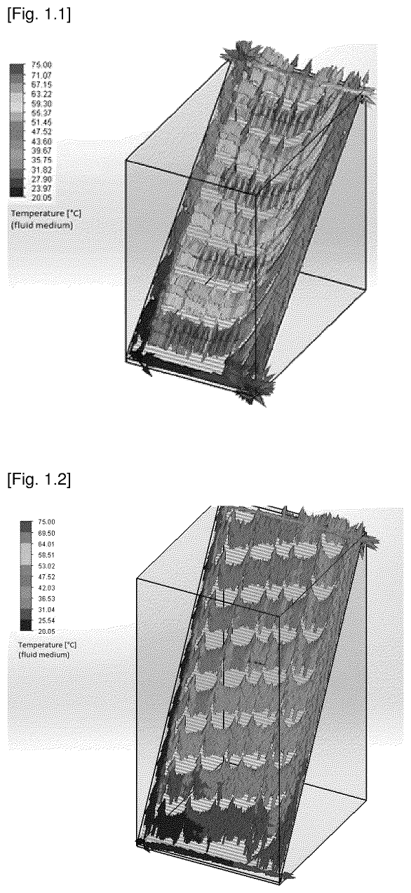

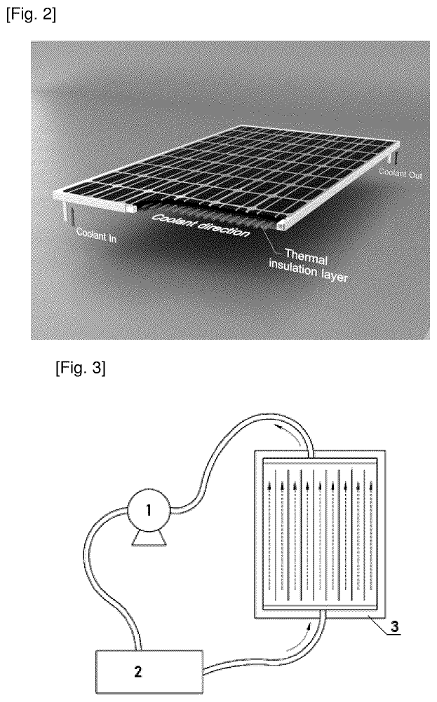

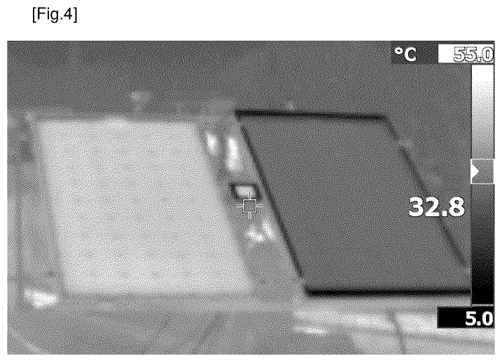

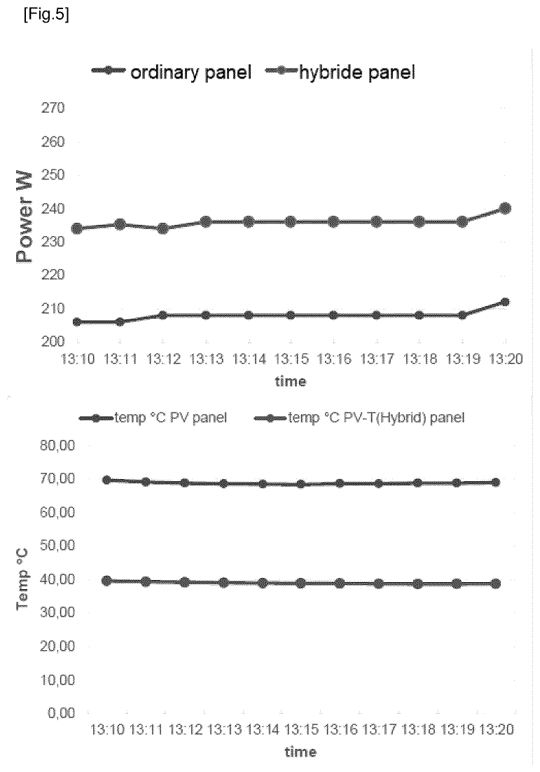

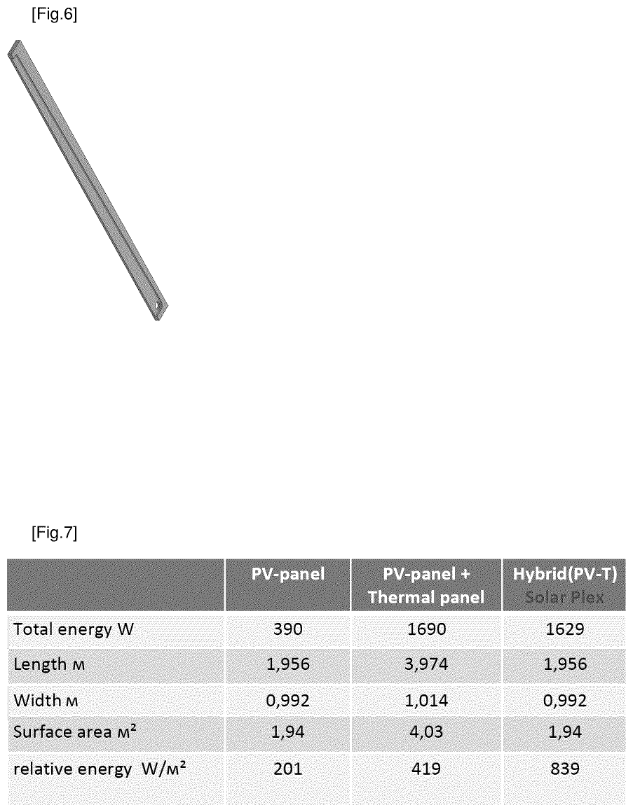

### DESCRIPTION OF EMBODIMENTS

While preferred embodiments of the invention have been disclosed in detail, it should be understood by those skilled in the art that various other modifications may be made to the illustrated embodiments without departing from the scope of the invention as described in the specification and defined in the appended claims.

### CITATION LIST

### Patent Literature

PTL1:
UA 51073 U, publ. 25 Jun. 2010
UA 55862 U, publ. 27 Dec. 2010
UA 110846 U, publ. 25 Oct. 2016
UA 140944 U, publ. 25 Mar. 2020
U.S. Pat. No. 4,392,008A, publ. 5 Jul. 1983
U.S. Pat. No. 4,545,365A, publ. 8 Oct. 1985
US2002189662A1, publ. 19 Dec. 2002
US2007186922A1, publ. 16 Aug. 2007
US2013036752A1, publ. 14 Feb. 2013
KR20130071830A, publ. 1 Jul. 2013
JP2014020759A, publ. 20 Aug. 2015
US2016322932A1, publ. 3 Nov. 2016
RU2731162C1, publ. 31 Aug. 2020

### Non-Patent Literature

NPL1: Huaxu Liang et al. Full-Spectrum Solar Energy Utilization and Enhanced Solar Energy Harvesting via Photon Anti-Reflection and Scattering Performance Using Biomimetic Nanophotonic Structure DOI:10.30919/esee8c456

1. A hybrid solar panel, comprising a photovoltaic panel coupled with transparent liquid thermal collector, characterized in that the transparent liquid thermal collector is the multi-channel polymer panel filled with the coolant, coolant supply inlet and drain outlet pipes, the inlet of the coolant supply to the polymer panel is below the coolant outlet, and the cross-section of the coolant supply pipe is 1.5-20 times smaller than the total cross-section of the thermal collector channels.

2. A hybrid solar panel according to claim 1, is characterized in that the heat adsorber is a coolant with the absorption of solar radiation in the range lower 400 nm and higher 1100 nm.

3. A hybrid solar panel, according to claim 1, comprises a second generating surface.

4. A hybrid solar panel according to claim 1, characterized in that the thermal adsorber is selectively transparent in the range of 400-1100 nm.

5. A hybrid solar panel, according to claim 3, additionally comprises a light reflector located behind the back of the panel.

6. A transparent liquid thermal collector for cooling of the photovoltaic panels, comprising a multi-channel polymer panel, supply pipe and coolant outlet pipe, heat adsorber, characterized in that the coolant inlet to the polymer panel is below the coolant outlet, and the cross-section of the coolant supply pipe is less than the total cross-section of the channels of the thermal collector in 1.5-20 times.

7. A thermal collector according to claim 6, characterized in that the adsorber is a coolant with the absorption of solar radiation in the range lower 400 nm and higher 1100 nm.

8. A thermal collector according to claim 6, is characterized in that the coolant in the collector is fed from the bottom up.

9. A thermal collector according to claim 6, is characterized in that the inlet and outlet collectors have a shape that ensures uniform and laminar distribution of fluid coolant and its movement over the entire plane of the panel.

10. A method of increasing the efficiency of photovoltaic panels, comprising the installation on the rear (opposite to the sun) surface, a liquid thermal collector for cooling according to claim 6.

11. A method according to claim 10, wherein the liquid thermal collector-cooling is coupled with the photovoltaic panel by lamination.
